(19) United States
(12) Patent Application Publication
(10) Pub. No.: US 2025/0156859 A1
(43) Pub. Date: May 15, 2025

(54) SMART PROXY SYSTEMS AND METHODS FOR TOKENIZATION AND POINT-TO-POINT ENCRYPTION SERVICES

(71) Applicant: Bluefin Payment Systems, LLC, Atlanta, GA (US)

(72) Inventors: Timothy William Barnett, Roswell, GA (US); Donal McCarthy, Waterford (IE); Marek Dabrowski, Dublin (IE)

(73) Assignee: Bluefin Payment Systems, LLC, Atlanta, GA (US)

(21) Appl. No.: 18/947,992

(22) Filed: Nov. 14, 2024

Related U.S. Application Data
(60) Provisional application No. 63/548,463, filed on Nov. 14, 2023.

(51) Int. Cl. G06Q 20/38

(52) U.S. Cl. CPC G06Q 20/38215; G06Q 20/3827

(57) ABSTRACT

A tokenization system has a proxy server that is configured to receive a message having a token and a template identifier. The proxy server is configured to store a plurality of templates for indicating how messages are to be processed. When the message with a token is received, the proxy server is configured to decrypt the message and retrieve, from memory, a template identified by the template identifier. The template indicates a location of the token within the message, and the proxy server uses the template to identify the token within the message. The proxy server then replaces the token within the message with data represented by the token and encrypts the message prior to transmitting it to a destination. In some embodiments, the proxy server also processes card-present payment requests based on the plurality of templates.

### CROSS REFERENCE TO RELATED APPLICATION

This application claims priority to U.S. Provisional Patent Application No. 63/548,463, entitled “Smart Proxy Systems and Methods for Tokenization and P2PE Services” and filed on Nov. 14, 2023, which is incorporated herein by reference.

### RELATED ART

Data security is an important concern in many types of applications and transactions. For example, in financial transactions, such as credit card or debit card payments, great effort and costs are devoted to protecting sensitive information from unauthorized users. In some transactions, point-to-point encryption (P2PE) is often used to keep sensitive information, such as account numbers or personal identification numbers (PINs), from being transmitted in the clear. In addition, other techniques, such as tokenization and PIN translation, may also be used to safeguard sensitive information from unauthorized access.

Tokenization generally refers to a process for which sensitive information to be transmitted in a message is swapped or replaced with non-sensitive information, referred to as a “token,” so that the message carries the token rather than the sensitive information. After transmission of the message, the token can be used to recover the sensitive information using a secure algorithm or information residing at the point of reception. Thus, if the message is intercepted or otherwise acquired by an unauthorized user during transmission, such user should be unable to use the contents of the message to recover the sensitive information even if the unauthorized user is able to break the message's encryption or other security measures.

The security measures used to protect sensitive information transmitted from one point to another can be complicated and costly to implement. For example, encryption and tokenization can consume considerable processing resources and also require complicated protocols and actions that can be challenging to implement successfully without error.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an embodiment of a communication system that employs tokenization to protect sensitive information.

FIG. 2 is a block diagram illustrating an embodiment of a proxy server, such as is depicted by FIG. 1.

FIG. 3 is a flowchart illustrating a method for processing a message for performing detokenization at a proxy server, such as is depicted by FIG. 1.

FIG. 4 is a block diagram illustrating an embodiment of a communication system having a proxy server that is configured to perform tokenization and also process card-present payment requests.

### DETAILED DESCRIPTION

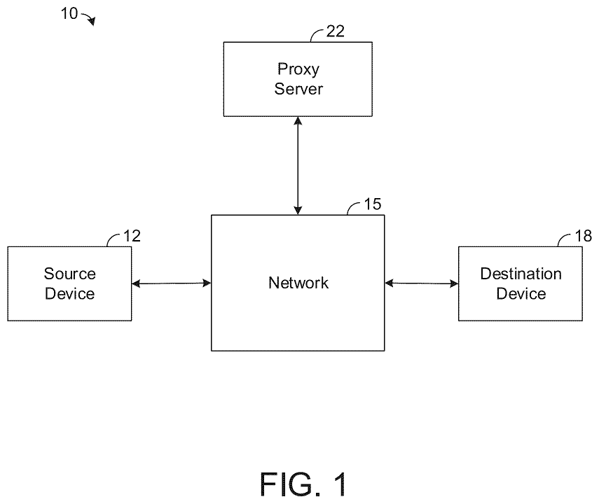

FIG. 1 depicts a communication system 10 for communicating messages. As shown by FIG. 1, the system 10 comprises a source device 12 that is configured to transmit messages through a network 15 to a destination device 18. Each of the source device 12 and the destination device 15 may be any type of device capable of communicating messages and processing data, such as a laptop, desktop, or handheld computer, a server, a smartphone, or other type of data processing device known in the art. The network 15 may comprise any network or combination of networks for communicating messages, including local area networks (LANs), wide area networks (WANs), and/or other types of known networks. As an example, the network 15 may comprise the Internet and possibly one or more other networks (e.g., a cellular network) for accessing the Internet.

The system 10 shown by FIG. 1 may also comprise a proxy server 22 (which also may be referred to as an “orchestration server”) that is coupled to the network 15 and is configured to communicate with the source device 12 and the destination device 18 through the network 15. In some embodiments, when the source device 12 has a message to be transmitted to the destination device 18, the source device 12 transmits the message to the proxy server 22 rather than transmitting the message directly to the destination device 18. The proxy server 22 is configured to perform various processing on the message, such as tokenization/detokenization, encryption/decryption, or other data security processes, before forwarding the message to the destination device 18.

For illustrative purposes, the system 10 will be described hereafter in the context of processing financial payment requests, such as credit card or debit card payment requests, transmitted from the source device 12. In such an embodiment, the source device 12 may be associated with a merchant and comprise a point-of-sale (POS) terminal that receives credit card or debit card information of a user and submits a payment request for transferring funds from the financial account associated with the credit card or debit card to a financial account associated with the merchant. In such an example, the destination device 18 may comprise a payment server owned or operated by a bank or other financial institution for receiving the payment request and effectuating the requested payment if the payment request is approved. However, it should be emphasized that the proxy server 22 may be employed in other applications, including non-financial applications, for similarly processing sensitive information of any type being communicated between a source device 12 and a destination device 18. As an example, the proxy server 22 may be similarly configured to process medical information that may be subject to Health Insurance Portability and Accountability Act (HIPAA) requirements.

In the context of a financial payment transaction, the information to be transmitted in a payment request may include Payment Card Industry (PCI) data subject to various requirements that must be adhered to in order to remain PCI compliant. Tokenization may be used to remove at least some of the PCI information from the message transmitted by the source device 12, thereby relieving the owner or operator of the source device 12 from at least some of the PCI requirements.

As an example, assume that a field of a payment request to be transmitted is for a string of PCI data, referred to in this example as “original data.” Rather than inserting the original data into the field, the source device 12 may instead insert a token previously received from the proxy server 22 that may be used by the proxy server 22 to recover the original data. In this regard, the proxy server 22 may be preconfigured to store a mapping that maps the token to the original data. For example, the proxy server 22 may have a relational database having entries that maps tokens to original data. When the proxy server 22 receives the payment request from the source device 12, the proxy server 22 may parse the message to locate the token, map the token to the original data, and then replace the token with the original data in the message before forwarding it to the destination device 18. In other embodiments, rather than maintaining a database of tokens, the proxy server 22 may use an algorithm to convert the token to the original data. In any event, regardless of the tokenization process used, the original data is not actually transmitted by the source device 12 helping to keep the source device 12 out of the scope of PCI compliance. Techniques for performing tokenization are described in commonly assigned U.S. Pat. No. 11,070,534, entitled “Systems and Processes for Vaultless Tokenization and Encryption” and issued on Jul. 20, 2021, which is incorporated herein by reference.

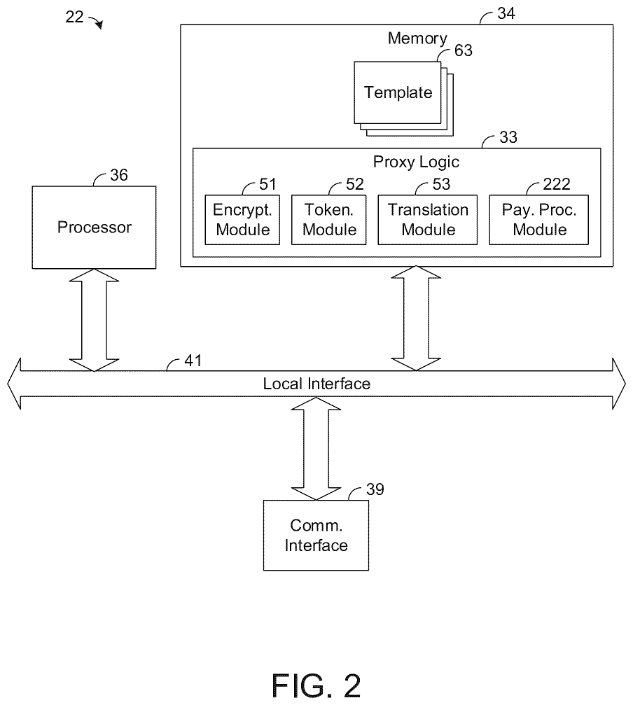

FIG. 2 depicts an embodiment of the proxy server 22. As shown by FIG. 2, the proxy server 22 comprises logic 33, referred to herein generally as “proxy logic,” for generally controlling the operation of the server 22, as will be described in more detail hereafter. The proxy logic 33 can be implemented in software, hardware, firmware or any combination thereof. In the proxy server 22 illustrated by FIG. 2, the proxy logic 33 is implemented in software and stored in memory 34 of the server 22.

Note that the proxy logic 33, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The proxy server 22 depicted by FIG. 2 comprises at least one conventional processor 36, such as a digital signal processor (DSP) or a central processing unit (CPU), that communicates to and drives the other elements within the server 22 via a local interface 41, which can include at least one bus. As an example, the processor 36 may be implemented with a conventional microprocessor that is configured to retrieve and execute instructions stored in memory 34. Furthermore, communication interface 39, such as at least one modem or other type of transceiver (e.g., a cellular radio), may be used to communicate with the network 15 (FIG. 1).

As shown by FIG. 2, the proxy logic 33 may have a plurality of modules, such as an encryption module 51, a tokenization module 52, and a translation module 53, that are configured to perform various functions for processing information from a received message. As an example, the encryption module 51 may be configured to encrypt or decrypt at least a portion of a received message (e.g., process the message for P2PE), and the tokenization module 52 may be configured to perform tokenization or detokenization on a portion of the message. Further, the translation module 53 may be configured to identify one or more parameters within the payload (e.g., a personal identification number (PIN), account number, and/or other parameter) within the message and to translate each such parameter to a new value. In other embodiments, the proxy logic 33 may have other types of modules (not shown) for performing other types of functions.

Note that to enable encryption and decryption at the proxy server 22, the encryption module 51 may store an encryption key of an encryption key pair, and the source device 12 may store the other encryption key of the encryption key pair. Using known encryption/decryption techniques, such keys may be used to encrypt and decrypt data transmitted between the proxy server 22 and the source device 12. For example, when a message is to be transmitted from the source device 12 to the proxy server 22, the source device may use its key to encrypt the message, and the encryption module 51 may use its key to decrypt the message. Similarly, the encryption module 51 and the destination device 18 may store an encryption key pair for enabling encryption and decryption of messages transmitted between the destination device 18 and the proxy server 22.

As further shown by FIG. 2, the server 22 also has a plurality of templates 63 stored in memory 34. Each template 63 is associated with a template identifier that uniquely identifies the template 63 from other templates 63, and each such template 63 indicates the actions (e.g., functions) that are to be performed on a received message. As will be described in more detail below, each template 63 also identifies the portion of the message to which a respective action (e.g., detokenization or decryption) is to be performed. For example, if detokenization is to be performed on a message, the template 63 used to process the message identifies the portion (e.g., field or fields) of the message containing a token. The tokenization module 52 uses such information from the template 63 to find the token in the message and then replace the token with the original data associated with that token. Thus, it is unnecessary for the message to be modified by the source device 12 to insert specialized markers (e.g., unique characters or data elements) that designate the location of the token within the message, as described in more detail below.

Note that a template 63 to be used for a given message may be preconfigured (prior to the transmission of the message) by a user, such as a user associated with the source device 12. This gives the user the ability to control how the message is processed by the proxy server 22, including which actions are performed on the message and which portions of the message are processed by each such action.

For example, a user associated with the source device 12 (e.g., an employee of the organization that owns or operates the source device 12) may communicate with the proxy server 22 during a registration session that occurs prior to transmission of a message by the source device 12. In the registration session, the user may be permitted to create a template and define the parameters of the template. As an example, if the user wishes for the proxy server 22 to perform detokenization on a portion of the message, the user may define the template 63 to indicate that detokenization is to be performed on the message and also to indicate the location within the message of the token to be swapped out of the message by the detokenization process.

In addition, when the message is transmitted to the proxy server 22, the header of the message may have a field for the template identifier of the template 63 to be used for processing the message. Using such template identifier, the proxy logic 33 identifies the template 63 to be used to process the message and then determines from the identified template 63 the actions to be taken to process the message. The proxy logic then performs the action on the indicated portions of the message. For example, for detokenization, the proxy logic 33 may call or otherwise invoke the tokenization module 52, which is configured to use the identified template 63 to identify the location of the token within the message and then replace the token with the original data that is associated with the token. For decryption, the proxy logic 33 uses the identified template 63 to identify the portion of the message to be decrypted and then calls or otherwise invokes the encryption module, which is configured to decrypt the identified portion. Yet other actions (e.g., PIN translation or some other action) may be performed on the message as indicated by the identified template 63.

Thus, the user of the source device 12 has control over how a message is to be processed by the proxy server 22. In this regard, the user may define the templates 63 that are used for messages from the source device 12 and then control which template 63 is applied to a given message by controlling the template identifier that is included in the message. Therefore, not only can the user control the actions to be performed for a given template 63, but the user can also control which template 63 is applied to which message transmitted from the source device 12. In other embodiments, the templates 63 may be defined and controlled by different users or by different techniques as may be desired.

Note that there are various techniques that may be used for a template 63 to indicate the location of a portion of a received message to be processed (e.g., identify a token within the message for processing by a detokenization process). For example, in defining the payload for a payment request having a token that is to be detokenized, it is possible to include specialized markers that indicate the beginning and end of the token. In this regard, a special character indicating the start of a token may be inserted into the payload just before the token and a special character indicating the end of the token may be inserted into the payload just after the token. Thus, the tokenization module 52 may be configured to analyze the payload to find these two special characters and extract the values between the special characters as the token to be detokenized. Such a technique burdens the source device 12 to control the format of the message being transmitted to appropriately mark the portion of the message containing the token. In addition, the inclusion of specialized markers may help a potential hacker to identify which portion of the message has been tokenized.

In one embodiment, the payloads of the payment requests received from the source device 12 are in a particular format, which includes path expressions that can be used to identify nodes within the text, including a node that contains the value to be accessed for processing (e.g., the token that is to be detokenized or data that is to be tokenized). In this regard, the text can be parsed or otherwise analyzed to find the path expressions of the defined path to the node, noting that the node to be accessed follows the last path expression of the path. As an example, the payload of a message received by the proxy server 22 may be written in Extensible Markup Language (XML), and the XPATH function defined by XML protocol may be used to identify the node within the payload that contains the token to be detokenized. In such an embodiment, the user defining the template 63 for the message may include, in the template 63, the path expressions defining the path to the node containing the token, and such information may be used by the proxy logic 33 to locate the token within the payload of the received message. The proxy logic 33 may then replace the value at the node (i.e., the token) with the original data for the token before forwarding the message to the destination device 18 (FIG. 1). In other examples, other languages, formats, and techniques may be used to identify the token to be detokenized. As an example, the payload may be written in JavaScript Object Notation (JSON), and JSONPATH may be used in a manner similar to XPATH described above in order to follow a path to find the token to be detokenized.

The use of templates 63 to identify the locations of portions of the message to be processed by a certain action (e.g., identify the token to be detokenized or data that is to be tokenized) allows the user during registration to define how the message is to be controlled by the proxy server 22 without requiring the insertion of special characters to mark such portions of the messages. In other embodiments, yet other techniques may be used to indicate the location of a token with a message and/or to indicate other portions of the message to be processed by a certain function (e.g., decryption).

Note that the templates 63 may be used, not only to define the actions to be performed on messages received from the source device 12, but also to define actions to be performed on the replies to the messages, such as a reply message from the destination device 18 approving or disapproving the payment request. For example, as described above, a template 63 used for a message defining a payment request from payment terminal (which may be the source device 12 for such message) to a bank server (which may be the destination device 18 for such message) may indicate that a detokenization process is to be performed on the message in order to replace a token in the message with original data associated with the token. In such example, the template 63 may also indicate that a tokenization process is to be performed on the message's reply from the bank server in order to replace data in the reply with a token that can be used by the source device 12 to recover such data. The reply includes information that can be used to correlate the reply with the original payment request, and the proxy logic 33 is configured to use such information to identify the template 63 previously used to process the payment request. The proxy logic 33 is configured to use this template 63 to determine how to process the reply. In the foregoing example, the proxy logic 33 may use the template 63 to determine that a tokenization process is to be used, and similar techniques (e.g., path expressions) may be used to indicate the location of the data to be tokenized.

In the above example, the reply includes a destination address that identifies the payment terminal (which may be considered as the destination device 18 for the reply) and source address that identifies the bank server (which may be considered as the source device 12 for the message). Both messages may include a common tag, such as a transaction identifier that identifies the financial transaction to which both messages are associated, and the proxy logic 33 may associate the two messages within one another (e.g., a payment request and a reply to the payment request) based on the common tag in both messages.

Note that, once an action and the location in the message affected by the action have been identified, the proxy logic 33 may use known techniques for performing the action. As an example, known techniques for performing tokenization or detokenization may be performed, including known techniques for determining the information to be inserted into the message. In some embodiments, the template 63 applied to the message may indicate not only the action and the message location but also indicate how to determine the information (e.g., token or data) to be inserted into the message. For example, the template 63 may include the information to be inserted so that the proxy logic 33 may retrieve it from the template 63 in performing the action. In other examples, the template 63 may identify or otherwise indicate the algorithm to be used to determine the information to be inserted into the message. The template 63 may include executable instructions (e.g., a script) capable of being executed by the processor 36 or otherwise to perform the action (e.g., process a token from the message to determine the information used to replace the token). Yet other techniques for determining the information to be inserted into the message or performing other actions are possible.

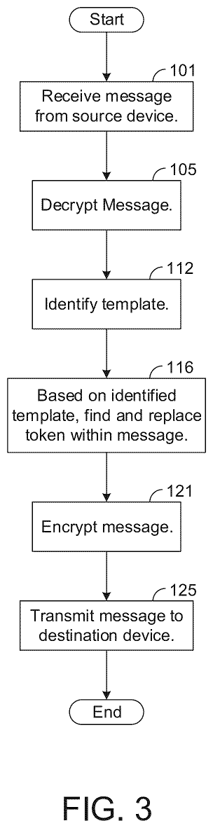

A use and operation of the proxy server 22 in performing detokenization on a message will be described with reference to FIG. 3.

As shown by block 101 of FIG. 3, the proxy server 22 receives from the source device 12 a message destined for the destination device 18. In this regard, the message may include a header that includes various overhead information for communicating and processing the message, such as a destination address identifying the destination device 19 as the message's destination and a template identifier identifying the template 63 to be used for processing the message at the proxy server 22. In one example, the message may be a payment request for a financial payment transaction. Specifically, the message's payload may include sensitive parameters associated with the financial account for the transaction, such as account numbers of the financial accounts to be used in the transaction, a PIN associated with at least one of the accounts, and/or other known parameters typically included in payment requests. In other examples, other types of messages are possible in other examples. In the current example, at least one of the parameters (e.g., an account number) may be tokenized such that it includes a token used in place of the actual parameter.

As shown by block 105 of FIG. 3, the proxy logic 33 of the proxy server 22 decrypts the message, and the proxy logic 33 uses the template identifier of the message to identify the template 63 to be used to process the message, as shown by block 112. In the current example, the template 63 indicates that a detokenization process is to be performed, and the template 63 also indicates the location in the message (e.g., in the message's payload) of the token to be detokenized. For example, as described in more detail above, the template 63 may include expressions that define a path to the token within the message. Using the template 63, the proxy logic 33 searches the message and finds the token within the message. The proxy logic 33 then replaces the token with the original data represented by the token, as shown by block 116 of FIG. 3. Note that, if the template indicates that other processes are to be performed on the message, such as PIN translation, the proxy logic 33 may perform such other processes as may be desired.

After the processes indicated by the template 63 are performed, the proxy logic 33 encrypts the message, as shown by block 121 of FIG. 3, and transmits the message to the destination device 18, as shown by block 125. Note that any number of parameters may be tokenized by the destination device 12 and detokenized by the proxy server 22, as described above. For example, each PCI parameter subject to PCI requirements (or other parameters subject to applicable compliance standards) may be tokenized such that PCI information is not actually processed by the source device 12e, thereby taking the source device 12 out of the scope of PCI compliance.

Note that the techniques described above may be used to perform tokenization by the proxy server 22 on various types of transactions, including “card-not-present” payment transactions. As known in the art, a card-not-present payment transaction involves a payment request form a merchant who does not have physical access to a consumer's credit or debit card, such as when the consumer is making an online purchase or when the merchant is charging the consumer for a recurring (e.g., monthly) expense. By using the tokenization process described above, it is unnecessary for the merchant to retain the customer's PCI information (e.g., credit card or debit card number) and, thus, avoid having to comply with applicable PCI standards. As an example, instead of storing the customer's credit card or debit card number, the merchant may instead store a token associated with such credit card or debit card number by the proxy server 22 and use the token to submit payment requests. When the proxy server 22 receives such a payment request, the proxy server 22 is configured to replace the token with the customer's actual credit card or debit card number and forward the payment request to the destination device 18 for approval. Thus, the financial transaction may be completed without the merchant having access to the customer's credit card or debit card number.

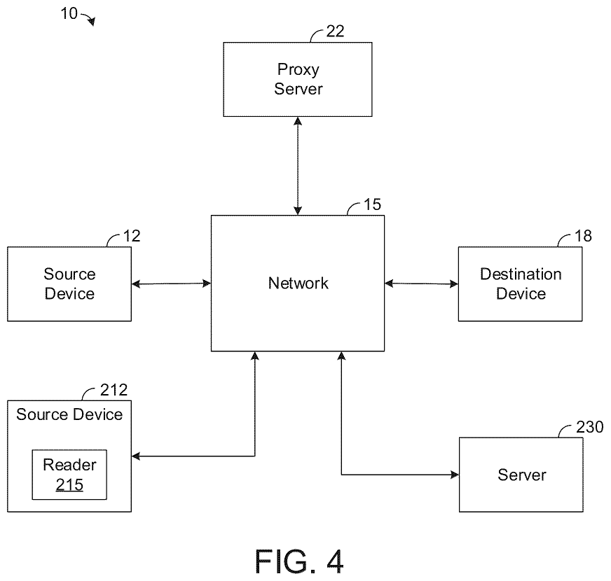

In some embodiments, the same proxy server 22 may be configured to process both card-not-present and card-present payment transactions (although processing of both types of payment transaction is unnecessary in other embodiments). As known in the art, a card-present payment transaction involves a payment request form a merchant who has physical access to a consumer's credit or debit card, such as when the consumer is making an in-store purchase. In this regard, as shown by FIG. 4, a source device 212 may comprise a payment reader 215 that is physically interfaced with a consumer's credit card or debit card. As an example, using the payment reader 215, the consumer may swipe, insert, or tap his or her credit card or debit card to cause an exchange of information between the card and the reader 215, including transmission of sensitive PCI information from the card to the reader 215. Such information may be encrypted and transmitted to the proxy server 22 by the reader 215 as part of a card-present payment request.

As shown by FIG. 4, the proxy logic 33 may comprise a payment processing module 222 that is configured to process payment requests from the source device 212. The payment processing module 222 is configured to use the templates 63 to process a card-present payment request from the source device 212 via techniques similar to those described above for tokenization. Specifically, for such a payment request, the source device 212 may be configured to include a template identifier for a template 63 that is to be used to process the payment request.

As an example, the identified template 63 may identify an address of the destination device 18 of a particular payment processor (i.e., financial institution that issued the credit card or debit card) to approve the payment request, and such template 63 may also provide information indicating how the message to the identified destination 18 is to be formatted. In addition, the template 63 may indicate the encryption key to be used for communication with the identified destination 18. Based on the identified template 63, the payment processing module 222 is configured to convert the payment request from the source device 212 into a form suitable for reception and approval by the destination device 18. This may include inserting the address of the destination device 18 into the message so that it is received by the destination device 18 as well as other formatting that may be appropriate. As an example, tags or fields of the original payment request may be removed or rearranged, as indicated by the identified template 63, to make the payment request compatible with the format used by the destination device 18. If the payment request includes a token, the proxy logic 33 may invoke the tokenization module 52 to detokenize a portion of the message before it is sent to the destination device for approval. Once the payment request is approved, the response from the payment processor may be reformatted in a similar manner based on information in the identified template 63 before being forwarded by the proxy server 22 to the merchant.

Notably, the use of the templates 63 as described above permits a merchant to easily change which payment processor is used for payments by simply changing the template identifier that is submitted with payment requests. For example, assume that a merchant uses a particular payment processor to process payments made by its customers and, due to a technical problem, the service by the payment processor is interrupted such that payments cannot be approved at least temporarily. Rather than waiting for the problem to be corrected, the merchant can reconfigure the source device 212 to include a different template identifier that identifies a template for sending payment requests to a different destination device 18 associated with a different payment processor, referred to hereafter as “new payment processor.” Thus, upon receiving a payment request with the new template identifier, the proxy server 22 accesses the identified template 63, which causes the proxy server 22 to format the payment request for reception by a destination device 18 of the new payment processor, including inserting the address of such destination device 18 into the payment request. Thus, the payment request is sent to the destination device 18 of the new payment processor thereby enabling the payment request to be approved without waiting on the service provided by the original payment processor to be restored.

Note that the source device 212 may use the same encryption key to communicate payment requests regardless of the destination devices 18 that are to be used to approve the payment requests. In this regard, the encryption key used by each source device 12, 212 is for communication between the proxy server 22 and the source device 12, 212 such that it is unnecessary for the source device 12, 212 to be aware of the encryption key used for the destination device 18. Thus, it is unnecessary for the encryption key in a source device 12, 212 to be updated when communication with a new destination device 18 (e.g., a new payment processor) is desired.

In some embodiments, a template 63 identified by a message from a source device 12, 212 may indicate one or more specific actions or a sequence of actions to be performed in processing the message. Thus, a user of the source device 12, 212 may control what actions are performed to process a given message by controlling the template identifier that is provided with the message. Such actions may include any action as may be desired, such as any of the actions described herein (e.g., encryption/decryption, tokenization/detokenization, adding or removing information from the message, reformatting the message, etc.). The actions may also include contacting third-party services or sending notices to third parties.

As an example, one action may be to contact a third-party server 230 (FIG. 4) to confirm that a user associated with a message is above a certain age (i.e., perform age verification). For example, the message may define an application for credit that requires the user submitting the application to be above a certain age, and the proxy logic 33, based on the template 63 identified by the message, may be configured to communicate with the third-party server 230 and continue processing the message if the age requirement is satisfied. In some embodiments, the message being sent to the destination device 18 may be updated based on information obtained from the third-party server 230. As an example, an indication that the user's age has been verified may be indicated in the message.

In some embodiments, the template 63 may indicate actions to be taken in both processing the message as well as processing responses received to a message. As an example, assume that a template 63 indicates the following actions are to be performed for a payment request: (1) decrypt the payment request, (2) replace a credit card or debit card number with a token, (3) format the payment request for a particular destination device 18, (4) send the payment request to the destination device 18, and (5) send the token to an address associated with the merchant of the transaction in response to an approval of the payment request. Upon receiving a payment request having a template identifier identifying the foregoing template 63, the proxy logic 33 based on the template 63 may determine that the payment request is to be decrypted and then invoke the encryption module 51 to decrypt the payment request. Once the decryption is performed, the proxy logic 33 based on the template 63 may invoke the tokenization module 52 to replace the credit card or debit card number in the payment request with a token. Once this tokenization is performed, the proxy logic 33 based on the template 63 may invoke the payment processing module 222 to process the message for reception by a destination device 18 (which may be identified by the template 63). Once the payment request is so processed, the proxy logic 33 based on the template 63 may transmit the payment request to the identified destination device 18. Once a response approving the payment is received from the payment processor, the proxy logic 33 based on the template 63 may provide the token used in the payment request to the merchant. As an example, the proxy logic 33 may insert the token in the response before transmitting it to the merchant.

Thus, in processing the payment request, the proxy logic 33 performs the sequence of actions indicated by the template 63. To change the actions performed on a given message (e.g., payment request), a user can either change the template identifier that is included with the message or update the template 63 that is identified by the template identifier to be used with the message. In other examples, other types of actions and sequences of actions may be indicated by the templates 63.

In addition, the defined actions may have inputs and outputs. As an example, an output of a first action may be used as input to a second action. For example, a first action may involve determination of the age of a user associated with a message by contacting a third-party server 230, and a subsequent may use the determined age as input to make control decisions on how the message is to be further processed. In other examples, other types of actions and other types of input and output are possible.

Note that an action of tokenizing a credit card or debit card number in a card-present payment request and then providing the merchant with the token used to replace the credit card or debit card number, as described in the above example, may have various advantages to the merchant. As an example, the tokenization module 52 may be configured such that the same credit card or debit card number is tokenized with the same token for all transactions, including both card-present payment requests and card-not-present payment requests. Thus, by providing the merchant with the token used for a card-present transaction, a merchant is able to associate that transaction with the same consumer who may have purchased from the merchant using the same credit card or debit card in a card-not-present transaction. In this regard, as described above, card-not-present transactions may be performed whereby the merchant uses a token rather than the credit card or debit card number of the consumer making the purchases. Thus, the merchant is aware of which card-not-present transactions are made by the same customer. By using the same token for card-present transactions and providing the token to the merchant, as described above, the merchant can also associate the card-present transaction with the same customer, thereby providing the merchant with more information on the purchasing habits and trends of its customers.

In various embodiments described above, the templates 63 are described as indicating various information, such as actions to be performed in processing a received message. In such embodiments, each template 63 may be a data structure storing data that can be interpreted by the proxy logic 33 to perform the functions recited herein. However, it is also possible for a template 63 to include executable code (e.g., one or more scripts) that may be executed by the processor 36 to perform the functions described herein. For example, when a message is received, the template 63 identified by the template identifier in the message may be retrieved by the proxy logic 33, which sends a script in the template 63 to the processor 36 for execution. Such script when executed by the processor 36 may cause the processor 36 to perform a sequence of actions for processing the message as described above. Thus, the actions performed to process a message that carries a certain template identifier can be changed by changing one or more scripts of the identified template 63.

Now, therefore, the following is claimed:

1. A tokenization method, comprising:
receiving, at a proxy server, a message having a token and a first template identifier;
decrypting the message with the proxy server;
storing, in memory, a plurality of templates;
retrieving, from the memory with the proxy server, a first template of the plurality of templates identified by the first template identifier, the first template indicating a location of the token within the message;
identifying, with the proxy server, the token within the message based on the first template;
based on the identifying, replacing the token within the message with data represented by the token;
encrypting the message subsequent to the replacing; and
transmitting the message from the proxy server to a destination device for the message.

2. The method of claim 1, wherein the first template defines a script, and wherein the method comprises executing the script by at least one processor of the proxy server causing the at least one processor to perform an action for processing the message.

3. The method of claim 1, further comprising:
receiving, at the proxy server, a card-present payment request having a second template identifier;
decrypting the card-present payment request with the proxy server;
retrieving, from the memory with the proxy server, a second template of the plurality of templates identified by the second template identifier;
processing, with the proxy server, the card-present payment request based on the second template;
encrypting the card-present payment request subsequent to the processing; and
transmitting the encrypted card-present payment request from the proxy server to a destination device identified by the second template.

4. The method of claim 3, further comprising:
replacing, at the proxy server, data in the card-present payment request with a second token;
receiving, at the proxy server, a response to the card-present payment request, the response indicating whether the card-present payment request is approved; and
inserting into the response, at the proxy server, the second token.

5. The method of claim 1, further comprising:
receiving, at the proxy server, a response to the message;
processing, at the proxy server, the response based on the first template; and
transmitting the response from the proxy server subsequent to the processing.

6. The method of claim 1, further comprising performing a sequence of actions indicated by the first template for processing the message at the proxy server.

7. The method of claim 1, wherein the first template includes path expressions defining a path to a node of the message containing the token, and wherein the identifying comprises locating the token within the message based on the path expressions from the template.

8. A proxy server for a tokenization system, comprising:
memory for storing a plurality of templates; and
at least one processor programmed with instructions that, when executed by the at least one processor, cause the at least one processor to:
receive a message having a token and a first template identifier;
decrypt the message;
retrieve, from the memory, a first template of the plurality of templates identified by the first template identifier, the first template indicating a location of the token within the message;
identify the token within the message based on the first template;
replace the token within the message with data represented by the token;
encrypt the message subsequent to replacing the token within the message; and
transmit the message to a destination device.

9. The proxy server of claim 8, wherein the first template defines a script, and wherein the instructions, when executed by the at least one processor, cause the at least one processor to execute the script for performing an action to process the message.

10. The proxy server of claim 8, wherein the instructions, when executed by the at least one processor, cause the at least one processor to:
receive a card-present payment request having a second template identifier;
decrypt the card-present payment request;
retrieve, from the memory, a second template of the plurality of templates identified by the second template identifier;
process the card-present payment request based on the second template;
encrypt the card-present payment request subsequent to processing the card-present payment request; and
transmit the encrypted card-present payment request to a destination device identified by the second template.

11. The proxy server of claim 10, wherein the instructions, when executed by the at least one processor, cause the at least one processor to:
replace data in the card-present payment request with a second token;
receive a response to the card-present payment request, the response indicating whether the card-present payment request is approved; and
insert into the response the second token.

12. The proxy server of claim 8, wherein the instructions, when executed by the at least one processor, cause the at least one processor to:
receive a response to the message;
process the response based on the first template; and
transmit the response from the proxy server subsequent to processing the response.

13. The proxy server of claim 8, wherein the instructions, when executed by the at least one processor, cause the at least one processor to perform a sequence of actions indicated by the first template for processing the message.

14. The proxy server of claim 8, wherein the first template includes path expressions defining a path to a node of the message containing the token, and wherein the instructions, when executed by the at least one processor, cause the at least one processor to identify the token by locating the token within the message based on the path expressions from the template.
